(19) United States
(12) Patent Application Publication
(10) Pub. No.: US 2026/0045544 A1
(43) Pub. Date: Feb. 12, 2026

(54) LITHIUM ELECTROCHEMICAL CELL COMPRISING A POSITIVE ELECTRODE BASED ON A LITHIUM MANGANESE IRON PHOSPHATE

(71) Applicant: SAFT, Levallois-Perret (FR)

(72) Inventors: Erwan DUMONT, AMBARES ET LAGRAVE (FR); Alexandre DOMINGET, BORDEAUX (FR); Elisabetta FEDELI, BORDEAUX (FR); Thibaut DUSSART, BORDEAUX (FR); Nadége ROUMEGOUS, AMBARESET LAGRAVE (FR)

(73) Assignee: SAFT, Levallois-Perret (FR)

(21) Appl. No.: 18/998,699

(22) PCT Filed: Jul. 11, 2023
(86) PCT No.: PCT/EP2023/069192

§ 371 Date: Jan. 27, 2025

(30) Foreign Application Priority Data
Jul. 29, 2022 (FR) FR2207830

(51) Int. Cl. H01M 10/0565; H01M 4/58

(52) U.S. Cl. CPC H01M 10/0565; H01M 4/5825; H01M 2300/0085

(57) ABSTRACT

The invention relates to an electrochemical element comprising: -a negative electrode comprising an active material; -a 2024/022807 positive electrode comprising an active material comprising a lithium manganese iron phosphate; -a gel electrolyte comprising a matrix which is a polymer obtained by crosslinking a monomer comprising at least two acrylate groups, whereby a liquid mixture comprising at least one solvent, at least one lithium salt and a free-radical polymerisation thermal initiator is incorporated therein.

### TECHNICAL FIELD OF THE INVENTION

The technical field of the invention is that of secondary electrochemical cells comprising a positive electrode (cathode) based on a lithium manganese iron phosphate.

### BACKGROUND OF THE INVENTION

An electrochemical cell, also referred to as a “cell” in the following, comprises an electrochemical bundle consisting of an alternation of positive electrodes and negative electrodes framing a separator impregnated with electrolyte. Each positive electrode and each negative electrode consists of a metal current collector supporting on at least one of its faces at least one active material and generally a binder and an electronically conductive material.

Rechargeable electrochemical cells of the lithium-metal type are known from the state of the art. Due to their high mass and volume energy densities, they constitute a promising source of electrical energy. They include at least one positive electrode, the active material of which may be a lithium phosphate of at least one transition metal, and at least one negative electrode, the active material of which is lithium or a lithium alloy.

A family of lithium phosphates of at least one transition metal consists of lithium manganese iron phosphates of formula LiₓMn_{1-y-z}Fe_{y}M_{z}PO₄ abbreviated LMFP with 0.8≤x≤1.2; 0.5≤1-y-z<1; 0<y≤0.5 and 0≤z≤0.2. These phosphates contain manganese, iron and one or more substituent elements symbolized by the symbol M. An interesting feature of these phosphates is that they have an operating voltage of up to 4.5 V compared to Li⁺/Li.

Moreover, it is known to use an electrolyte in gelled form in an electrochemical cell. The gelled electrolyte can be obtained by dissolving a polymer in an organic solvent. The gelled electrolyte is then contacted with the electrodes which gradually become impregnated therewith. The gelled form has the following advantages: in the event of accidental opening of the cell container, it prevents electrolyte from spreading into the environment in which the cell is placed. It also prevents lithium dendrites likely to form on the surface of the negative electrode from propagating towards the positive electrode and creating micro short circuits that are detrimental to the life of the cell. Compared with a liquid electrolyte, a gelled electrolyte improves the safety of the user of the cell.

However, it has been found that it is difficult to obtain good impregnation of the pores of an electrode by gelled electrolyte when the active material of this electrode is based on a lithium manganese iron phosphate. The pores of this type of electrode are small. Their average size is in fact less than 100 nm.

Therefore a way to improve the impregnation of the pores of the electrode by gelled electrolyte when the active material is a lithium manganese iron phosphate is sought. US 2005/0271939 discloses a secondary electrochemical cell comprising a negative carbon electrode and a positive electrode which is an oxide that can be selected from LiNiO₂, LiMn₂O₄, LiCoO₂, LiCoO_{0.92}Sn_{0.08}O₂, LiCo₁₋ₓNiₓO₂ and LiFePO₄. This document discloses that the electrolyte can be a gelled electrolyte containing a polymer obtained by copolymerization of a first monomer comprising an acrylic or allyl group and a cyano group and a second monomer comprising an unsaturation in the a position. This document does not disclose a secondary electrochemical cell comprising a negative lithium electrode and a positive electrode which is a lithium manganese iron phosphate.

### SUMMARY OF THE INVENTION

For this purpose, the invention proposes an electrochemical cell comprising:
a negative electrode comprising an active material;
a positive electrode comprising an active material comprising a lithium manganese iron phosphate;
a gel electrolyte comprising a matrix which is a polymer obtained by crosslinking a monomer comprising at least two acrylate groups, whereby a liquid mixture comprising at least one solvent, at least one lithium salt and a free-radical polymerization thermal initiator is incorporated therein.

According to one embodiment, the active material is selected from lithium metal and a lithium alloy.

According to one embodiment, the polymer results from the crosslinking of trimethylolpropane propoxylate triacrylate (TPPTA).

According to one embodiment, said at least one lithium salt consists of the combination of lithium hexafluorophosphate (LiPF₆) and lithium difluoro(oxalato)borate.

According to one embodiment, said at least one lithium salt consists of the ternary association of lithium hexafluorophosphate (LiPF₆), lithium bis(fluorosulfonyl)imide (LiFSI) and lithium difluoro(oxalato)borate.

According to one embodiment, said at least one solvent is a cyclic carbonate or a linear carbonate or a mixture thereof.

According to one embodiment, said at least one solvent of the electrolyte is selected from fluoroethylene carbonate (FEC), ethyl methyl carbonate (EMC) and a mixture thereof.

According to one embodiment, the free-radical polymerization thermal initiator is azobisisobutyronitrile (AIBN).

According to one embodiment, the active material of the positive electrode comprises:
from 50 to 99% by mass of lithium manganese iron phosphate,
from 1 to 50% by mass of a lithiated oxide of nickel, manganese and cobalt (NMC) and/or a lithiated oxide of lithium, nickel, cobalt and aluminum (NCA) or a mixture thereof.

According to one embodiment, the lithium manganese iron phosphate has the formula:
LiₓMn_{1-y-z}Fe_{y}M_{z}PO₄ where 0.8≤x≤1.2; 0.5≤1-y-z<1; 0<y≤0.5and 0≤z≤0.2 and
M is one or more chemical elements selected from the group consisting of B, Mg, Al, Si, Ca, Ti, V, Cr, Co, Ni, Cu, Zn, Y, Zr, Nb and Mo.

The invention also relates to a method for in-situ thermal polymerization of a gelled polymer electrolyte in an electrochemical cell, said method comprising the steps of:
(a) providing an assembly comprising at least one positive electrode comprising an active material comprising a lithium manganese iron phosphate, at least one separator and at least one negative electrode comprising an active material;
b) inserting the assembly into a container;
c) preparing a liquid mixture comprising at least one solvent, a monomer comprising at least two acrylate groups, at least one lithium salt and a free-radical polymerization thermal initiator;
d) impregnating the assembly with the liquid mixture;
e) raising the temperature of the assembly to a temperature sufficient to cause crosslinking of the monomer comprising at least two acrylate groups for a period ranging from 2 to 24 hours.

The invention is based on the discovery that the impregnation of a positive electrode based on LMFP can be improved by carrying out an in-situ polymerization of a monomer comprising at least two acrylate groups. The term “in-situ” means a polymerization of a monomer carried out in such a way that the solution containing the monomer is in contact with the assembly comprising said at least one positive electrode, said at least one separator and said at least one negative electrode. This assembly is introduced into the container of the cell prior to the polymerization.

It was also found that the impregnation by the gel electrolyte was improved for a monomer comprising at least two acrylate groups having a low molecular weight.

The improvement in the impregnation of the positive electrode results in an increase in the life of the cell in cycling as well as an increase in the coulombic efficiency, that is to say the ratio between the quantity of electricity discharged by the cell and the quantity of electricity charged in the cell during the charge preceding the discharge.

According to one embodiment, step e) is carried out at a temperature ranging from 55 to 80° C.

According to one embodiment, in step c), the mass percentage of monomer in the liquid mixture represents from 1 to 20% by mass of the mass of the assembly formed by said at least one solvent, said at least one lithium salt and the free-radical polymerization thermal initiator.

According to one embodiment, in step c), the mass percentage of monomer in the liquid mixture represents from 2 to 7% by mass of the mass of the assembly formed by said at least one solvent, said at least one lithium salt and the free-radical polymerization thermal initiator.

### BRIEF DESCRIPTION OF THE FIGURES

Embodiments of the invention are described below in more detail with reference to the attached figures.

FIG. 1 compares the double-layer capacitance of positive electrodes at 25° C. when the electrolyte is gelled by crosslinked TPPTA with that when the electrolyte is gelled by crosslinked PEGDA, for different frequencies after formation of the cells.

FIG. 2 compares the resistance at 25° C. of the gelled electrolyte obtained by crosslinking TPPTA with that of the gelled electrolyte obtained by crosslinking PEGDA, at different times, after formation of the cells.

FIG. 3 shows the variation of the capacity discharged by the cells of the examples as a function of the number of cycles.

FIG. 4 shows the variation in the percentage of retention of the initial capacity of the cells of the examples as a function of the number of cycles.

### DESCRIPTION OF EMBODIMENTS OF THE INVENTION

### Description of Gelled Polymer Electrolyte

The polymer acts as a matrix in the gelled electrolyte. It is obtained by crosslinking a monomer including at least two acrylate groups. Crosslinking refers to the formation of a polymer having a three-dimensional structure. The term “acrylate groups” includes in the following methacrylate groups. The monomer typically includes two, three or four acrylate groups. In a preferred embodiment, crosslinking occurs only in the presence of the monomer including at least two acrylate groups. The crosslinked polymer comprises at least one acrylate group.

According to one embodiment, the reaction mixture does not comprise a comonomer. Examples of monomers having two acrylate groups are poly(ethylene glycol) diacrylate (PEGDA), poly(ethylene glycol) dimethacrylate (PEGDMA), poly(propylene glycol) diacrylate (PPGDA), and poly(propylene glycol) dimethacrylate (PPGDMA). Mention can be made of di(propylene glycol) diacrylate, 1H,1H,6H,6H-perfluoro-1,6-hexyl diacrylate, 1H,1H,5H,5H-perfluoropentane-1,5-diyl diacrylate, and 2,2,3,3-tetrafluoro-1,4-butyl diacrylate. Poly(ethylene glycol) diacrylate (PEGDA) may have a number-average molecular weight ranging from 5000 to 10000 g/mol or from 6000 to 8000 g/mol. It can also have a molecular weight comprised between 500 and 1000 g/mole, preferably between 600 and 800 g/mole. It has been observed that low molecular weight monomers promote the impregnation of the pores of the electrodes by the gelled electrolyte.

Examples of monomers having three acrylate groups are trimethylolpropane triacrylate (TMPTA), pentaerythritol triacrylate, trimethylolpropane ethoxylate triacrylate, and trimethylolpropane propoxylate triacrylate (TPPTA).

An example of a monomer having four acrylate groups is pentaerythritol tetraacrylate (PETEA).

Among the monomers mentioned above, a preferred monomer is trimethylolpropane propoxylate triacrylate (TPPTA).

Crosslinking occurs by contacting the monomer with a free-radical polymerization thermal initiator and activating this initiator by heat. The degree of progress of crosslinking can be estimated by measuring the percentage of residual monomers in the reaction medium at different times during the reaction. Residual acrylate monomers are characterized by the presence of a C═C double bond in the vinyl group. This double bond can be detected by Fourier transform infrared spectroscopy (FT-IR). This technique can be used by a person skilled in the art to measure the amount of residual monomers. The crosslinking conditions are chosen to minimize the amount of residual monomers. The presence of a small amount of residual monomers can have a detrimental effect on the operation of the cell.

The electrolyte comprises one or more lithium salts that may be selected from lithium perchlorate LiClO₄, lithium hexafluorophosphate LiPF₆, lithium tetrafluoroborate LiBF₄, lithium hexafluoroarsenate LiAsF₆, lithium hexafluoroantimonate LiSbF₆, lithium trifluoromethanesulfonate LiCF₃SO₃, lithium bis(fluorosulfonyl)imide Li(FSO₂)₂N (LiFSI), lithium bis(trifluoromethanesulfonyl)imide LiN(CF₃SO₂)₂ (LiTFSI), lithium tris(fluoromethanesulfonyl)methylide LiC(CF₃SO₂)₃ (LiTFSM), lithium bis(pentafluoroethylsulfonyl)imide LiN(C₂F₅SO₂)₂ (LiBETI), lithium 4,5-dicyano-2-(trifluoromethyl)imidazolide (LiTDI), lithium bis(oxalato)borate (LiBOB), lithium difluoro(oxalato)borate (LiDFOB), lithium tris(pentafluoroethyl)trifluorophosphate LiPF₃(CF₂CF₃)₃ (LiFAP), lithium difluorophosphate LiPO₂F₂ and mixtures thereof.

A first preferred mixture of lithium salts consists of LiPF₆ and LiDFOB each used at a concentration of about 0.5 mol·L⁻¹.

A second preferred mixture of lithium salts consists of LiPF₆, LiFSI and/or LiTFSI and LiDFOB. Preferably, this second mixture consists of LiPF₆, LiFSI and LiDFOB. This ternary mixture allows to reduce the detrimental effect of the presence of residual acrylate monomers. These monomers in fact form a passivation layer on the surface of the negative electrode during the formation of the cell, that is to say the first charge/discharge cycle of the cell. This layer is resistive and contributes to increasing the internal resistance of the cell.

The monomer including at least two acrylate groups, said at least one lithium salt and the free-radical polymerization thermal initiator are dissolved in at least one organic solvent. The organic solvent may be selected from the group consisting of saturated cyclic carbonates, unsaturated cyclic carbonates, linear carbonates, linear ethers, cyclic ethers and their fluorinated derivatives. Preferred saturated cyclic carbonates are propylene carbonate (PC), ethylene carbonate (EC), butylene carbonate (BC) and a mixture thereof. An example of a fluorinated cyclic carbonate is monofluoroethylene carbonate (FEC). Vinylene carbonate may be used as an unsaturated cyclic carbonate. Preferred linear carbonates are dimethyl carbonate (DMC), ethyl methyl carbonate (EMC), diethyl carbonate (DEC), dipropyl carbonate (DPC) and a mixture thereof. Preferred linear ethers comprise dimethyl ether (DME), diethyl ether (DEE), and a mixture thereof. Preferred cyclic ethers comprise lactones, such as gamma-butyrolactone.

In a preferred embodiment, said at least one solvent is selected from the group consisting of cyclic carbonates, linear carbonates and a mixture thereof.

In a preferred embodiment, said at least one solvent comprises fluoroethylene carbonate (FEC).

In one embodiment, said at least one solvent is a mixture of a linear carbonate and fluoroethylene carbonate (FEC). The linear carbonate may be ethyl methyl carbonate (EMC).

In one embodiment, said at least one solvent is a mixture of fluoroethylene carbonate (FEC) and ethyl methyl carbonate (EMC) and the salt mixture consists of LiPF₆ and LiDFOB.

The free-radical polymerization thermal initiator may be a compound comprising one or more azo groups. Preferred initiators are those that are activated by a temperature ranging from 50 to 100° C. or from 60 to 90° C. or from 70 to 80° C. Moderate temperatures ranging from 55 to 75° C. are preferred. A free-radical polymerization thermal initiator comprising an azo group is azobisisobutyronitrile (AIBN).

### Description of the Positive Electrode and the Negative Electrode

The negative electrode comprises an active material preferably selected from lithium metal, a lithium alloy. It may also be silicon, graphite or an active material devoid of lithium. The term active material devoid of lithium designates a sheet made of a metal other than lithium. This metal does not form an alloy with lithium ions. The surface of the metal sheet is free of lithium metal before charging the cell and is covered with a layer of lithium during charging of the cell. The lithium alloy may be lithium alloyed with one or more of the elements selected from Mg, Al, Zn, Si, B, Ge, Ga, In and Sn. More preferably, the only active material of the negative electrode is lithium metal or a lithium alloy. The active material may be attached to a current collector which may be a copper strip.

At least one of the active materials of the positive electrode is a lithium manganese iron phosphate of formula: LiₓMn_{1-y-z}Fe_{y}M_{z}PO₄ where 0.8≤x≤1.2; 0.5≤1-y-z<1; 0<y≤0.5; 0≤z≤0.2 and M is selected from the group consisting of B, Mg, Al, Si, Ca, Ti, V, Cr, Co, Ni, Cu, Zn, Y, Zr, Nb and Mo.

In one embodiment, 0.7≤1-y-z≤0.9 or 0.75≤1-y-z≤0.90.

In one embodiment, 0.15≤y≤0.25.

Typical formulas of lithium manganese iron phosphate are LiMn_{0.8}Fe_{0.2}PO₄, LiMn_{0.7}Fe_{0.3}PO₄, LiMn_{2/3}Fe_{1/3}PO₄, and LiMn_{0.5}Fe_{0.5}PO₄.

In one embodiment, lithium manganese iron phosphate is the only active material of the positive electrode.

In another embodiment, the lithium manganese iron phosphate is associated with at least one lithium oxide of at least one transition metal of formula LiₓM_{1-y-z-w}M′_{y}M″_{z}M′″_{w}O₂ (LMO₂) where M, M′, M″ and M′″ are selected from the group consisting of B, Mg, Al, Si, Ca, Ti, V, Cr, Mn, Fe, Co, Ni, Cu, Zn, Y, Zr, Nb, W and Mo provided that at least one of M, M′, M″ and M′″ is selected from Mn, Co, Ni or Fe; M, M′, M″ being M′″ being different from each other; and 0.8≤x≤1.4; 0≤y≤0.5; 0≤z≤0.5; 0≤w≤0.2 and x+y+z+w<2.1. One of M, M′, M″ and M′″ may be Al with a stoichiometric index less than or equal to 0.1.

The lithium oxide of at least one transition metal may be a lithium nickel manganese cobalt (NMC) oxide or a lithium nickel cobalt aluminum (NCA) oxide compound of respective formulas:
Li_{w}(NiₓMn_{y}Co_{z}Mₜ)O₂ (NMC) where 0.9≤w≤1.1; 0<x; 0<y; 0<z; 0≤t; M being selected from the group consisting of Al, B, Mg, Si, Ca, Ti, V, Cr, Fe, Cu, Zn, Y, Zr, Nb, W, Mo, Sr, Ce, Ta, Ga, Nd, Pr, La and mixtures thereof,
Li_{w}(NiₓCo_{y}Al_{z}Mₜ)O₂ (NCA) where 0.9≤w≤1.1; 0<x; 0<y; 0<z; 0≤t; M being selected from the group consisting of B, Mg, Si, Ca, Ti, V, Cr, Mn, Fe, Cu, Zn, Y, Zr, Nb, W, Mo, Sr, Ce, Ga, Ta, Nd, Pr, La and mixtures thereof.

It can also be a mixture of NMC and NCA.

In one embodiment, the lithium oxide of at least one transition metal is NMC wherein 0.6≤x.

In one embodiment, the lithium oxide of at least one transition metal is NMC wherein 0.6≤x and 0.15≤y<0.40 or 0.20≤y≤0.30.

In one embodiment, the lithium oxide of at least one transition metal is NMC wherein 0.6≤x and 0.10≤z<0.30 or 0.15≤z≤0.25.

When the lithium manganese iron phosphate is mixed with a lithium oxide of at least one transition metal, such as NMC, the lithium manganese iron phosphate may represent from 50 to 99% or from 55 to 75% or from 60 to 80% by mass of the mass of the mixture. In another embodiment, the lithium manganese iron phosphate represents from 1 to 50% by mass of the mass of the mixture.

A separator is placed between a positive electrode and a negative electrode. The separator may consist of a layer of a material selected from the group consisting of polypropylene (PP), polyethylene (PE), polytetrafluoroethylene (PTFE), polyacrylonitrile (PAN), polyester such as polyethylene terephthalate (PET), polybutylene terephthalate (PBT), cellulose, polyimide, glass fibers. The separator may consist of several layers of the aforementioned materials, the layers being of the same nature or of different nature. A layer may be coated on one or both sides with a layer of ceramic, such as alumina, or with polyvinylidene fluoride (PVdF) or polyvinylidene fluoride-hexafluoropropylene (PVdF-HFP) or with an acrylate. A preferred separator consists of a layer of polyethylene coated on both sides with a layer of alumina.

### Description of the Method for Preparing the In-situ Gelled Polymer Electrolyte

In-situ polymerization of monomers including at least two acrylate groups allowed to improve the impregnation of the LMFP pores by the electrolyte. Ex-situ polymerization, that is to say carried out while the solution containing the monomer is not in contact with said at least one positive electrode, said at least one negative electrode and said at least one separator, does not allow to obtain such good impregnation of the electrodes.

An electrochemical bundle is prepared in a conventional manner. It is prepared by superimposing at least one positive electrode, at least one separator, at least one negative electrode, each positive electrode being separated from the negative electrode by a separator.

This can be a flat or spiral arrangement of the electrodes.

The assembly of said at least one positive electrode, said at least one separator and said at least one negative electrode is introduced into a container of the cell. The container may be of parallelepipedal or cylindrical format. It may also be a flexible bag formed after welding the edges of two multilayer films, each multilayer film comprising a metal layer, sandwiched between two layers of plastic material.

Appropriate amounts of the monomer, said at least one solvent, said at least one lithium salt and the thermal initiator are mixed to result in a liquid mixture. Generally, the mass percentage of the monomer ranges from 1 to 20% or from 5 to 10% or from 2 to 7% for a total mass of said at least one solvent, said at least one lithium salt and the free-radical polymerization thermal initiator of 100%. A low percentage of monomer allows to obtain a lower viscosity of the liquid mixture which improves the impregnation of the electrodes.

The total amount of the thermal initiator(s) for free-radical polymerization may represent from 0.1 to 3% by mass, ideally from 1 to 1.5% by mass relative to the mass of monomer.

The assembly is immersed in the liquid mixture at room temperature. A rest period generally ranging from 12 to 24 hours is preferably observed to improve the penetration of the liquid mixture into the pores of the positive and negative electrodes. The temperature is then increased to a value sufficient to activate the initiator and cause crosslinking of the monomer. The temperature is generally set in the range of 50 to 100° C., preferably 60 to 70° C. It may be set in the range of 60° C. to 70° C. when the free-radical initiator is azobisisobutyronitrile (AIBN). The heat is maintained for 2-24 hours, usually 5 to 15 hours depending on the amounts of monomer and free-radical initiator used. The use of the FT-IR technique allows to check whether the reaction mixture still contains compounds having a C═C double bond. The person skilled in the art is able to know when to stop applying the heat.

In the case of a rigid container of prismatic or cylindrical format, a cover comprising the current output terminals of the cell is placed on the opening of the container. The electrical connection of the positive terminal to the positive electrode and the electrical connection of the negative terminal to the negative electrode are made.

The cell closure can take place before or after crosslinking.

### EXAMPLES

Two pouch-sized electrochemical cells were fabricated. They differ in the composition of their gel electrolyte. The monomer in one of the cells of trimethylolpropane propoxylate triacrylate (TPPTA) with a number-average molecular weight of 644 g/mol. The monomer is polyethylene glycol diacrylate (PEGDA) with a number-average molecular weight of 6000 g/mol in the second cell.

The two cells each comprise an assembly consisting of a positive electrode and a negative electrode separated by a separator. The assembly is housed in a flexible pouch formed after welding the edges of two multilayer films, each multilayer film comprising a metallic layer of aluminum sandwiched between two layers of plastic material. The positive electrode comprises a mixture of active materials consisting of 60% by mass of LiMn_{0.8}Fe_{0.2}PO₄ and 40% by mass of LiNi_{0.6}Mn_{0.2}oCo_{0.2}O₂. The negative electrode consists of a 60 μm lithium sheet attached to a current collector which is a copper strip. The separator consists of a layer of polyethylene covered on both sides with a layer of alumina.

The gelled polymer electrolyte was obtained by in-situ crosslinking of the monomer in the pouch. For this purpose, a mixture of fluororethylene carbonate (FEC) and ethyl methyl carbonate (EMC) was first prepared in the proportions of 20 vol. %/80 vol. %. LiPF₆ and LiDFOB were added to the mixture, each at a concentration of 0.5 M. The free-radical polymerization thermal initiator was also previously added to the mixture at a rate of 0.1 mass % relative to the mass of the whole consisting of FEC, EMC, LiPF₆, LiDFOB and the monomer. The monomer was incorporated into the mixture at a rate of 5% by mass of monomer relative to the mass of the whole consisting of the monomer, the solvents, the lithium hexafluorophosphate (LiPF₆), the lithium difluoro(oxalato)borate (LiDFOB) and the free-radical polymerization thermal initiator. The liquid mixture was introduced into the pouch containing the positive electrode, the separator and the negative electrode. The crosslinking was triggered by exposing the pouch to a temperature of 70° C. for 7 hours.

The cells underwent formation consisting of two charge/discharge cycles at the C/10-D/10 rate and then underwent cycling at the C/5-D/2 rate. During the tests, the opposite faces of the cells were subjected to a compressive force of 1 bar.

Complex impedance measurements showed that the electrolyte resistance value stabilized more quickly for the cell whose electrolyte contained TPPTA than for the cell whose electrolyte contained PEGDA.

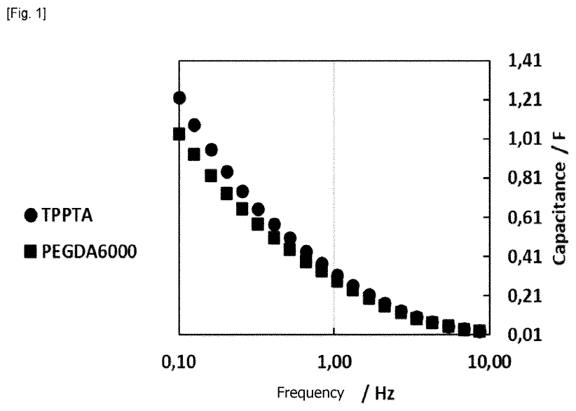

FIG. 1 compares the double layer capacitance of the positive electrodes at 25° C. when the electrolyte is gelled by crosslinked TPPTA with that when the electrolyte is gelled by crosslinked PEGDA, for different frequencies after formation of the cells. The highest double layer capacitance is obtained for the cell whose electrolyte is gelled by crosslinked TPPTA. This suggests a better impregnation of the electrodes by the electrolyte gelled by crosslinked TPPTA. One reason could be the lower molecular weight of TPPTA compared to that of PEGDA, which would induce a lower viscosity of the liquid mixture before monomer crosslinking.

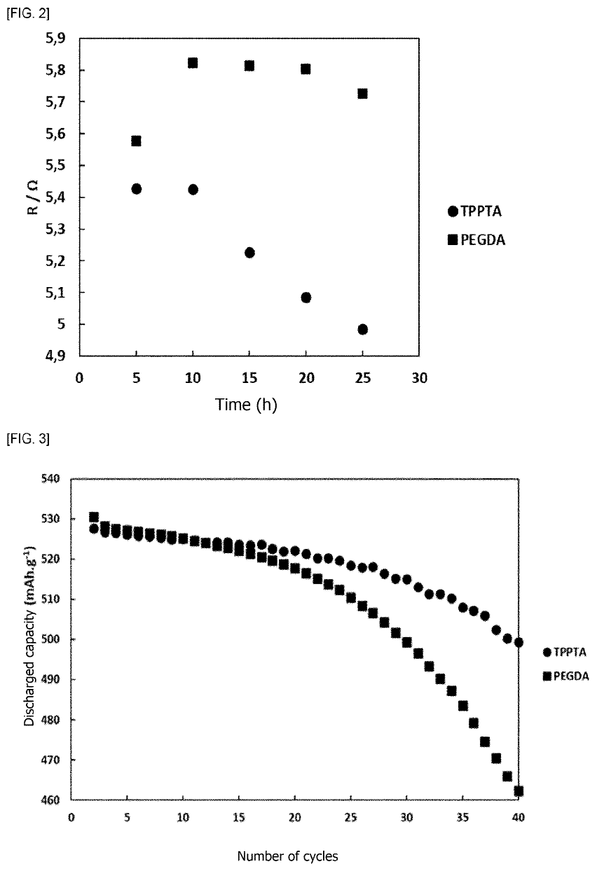

FIG. 2 compares the interface resistance between lithium electrodes with TPPTA-based or PEGDA-based gel electrolyte at 25° C. The resistance of this interface between TPPTA-based gel electrolyte and lithium is lower than that between PEGDA-based gel electrolyte and lithium. This result shows that the interface is less resistive and thus a lower polarization related to this interface will be obtained when the current passes. In addition, the resistance value between TPPTA-based gel electrolyte and lithium decreases more rapidly over time indicating a stabilization of the latter.

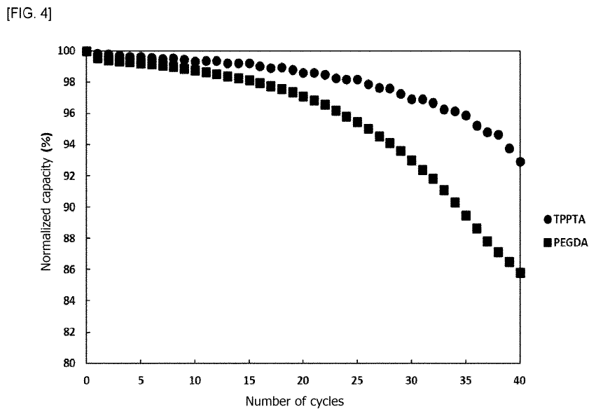

Both cells were cycled. The variation of the discharged capacity of the cells as a function of the number of cycles is shown in FIG. 3. FIG. 3 shows that up to about cycle number 12, the discharged capacity of the cell whose electrolyte is gelled with crosslinked PEGDA is slightly higher than that of the cell whose electrolyte is gelled with crosslinked TPPTA. Beyond this cycle, the cell whose electrolyte is gelled with crosslinked TPPTA has the highest discharged capacity.

The variation of the percentage of retention of the initial capacity as a function of the number of cycles is shown in FIG. 4. A rapid decrease in retention of the initial capacity can be noted for the cell whose electrolyte is gelled by crosslinked PEGDA. In addition, the coulombic efficiency of the cell whose electrolyte is gelled by crosslinked TPPTA is 1% higher than that of the cell whose electrolyte is gelled by PEGDA. These results show that the use of a low molecular weight monomer allows to increase the cycling life and the coulombic efficiency of the cell.

1. An electrochemical cell comprising:
a negative electrode comprising an active material;
a positive electrode comprising an active material comprising a lithium manganese iron phosphate;
a gel electrolyte comprising a matrix which is a polymer obtained by crosslinking a monomer comprising at least two acrylate groups, whereby a liquid mixture comprising at least one solvent, at least one lithium salt and a free-radical polymerization thermal initiator is incorporated therein.

2. The electrochemical cell according to claim 1, wherein the active material is selected from lithium metal and a lithium alloy.

3. The electrochemical cell according to claim 1, or wherein the polymer results from the crosslinking of trimethylolpropane propoxylate triacrylate (TPPTA).

4. The electrochemical cell according to claim 1, wherein said at least one lithium salt consists of the combination of lithium hexafluorophosphate (LiPF₆) and lithium difluoro(oxalato)borate.

5. The electrochemical cell according to claim 1, wherein said at least one lithium salt consists of the ternary association of lithium hexafluorophosphate (LiPF₆), lithium bis(fluorosulfonyl)imide (LiFSI) and lithium difluoro(oxalato)borate.

6. The electrochemical cell according to claim 1, wherein said at least one solvent is a cyclic carbonate or a linear carbonate or a mixture thereof.

7. The electrochemical cell according to claim 6, wherein said at least one solvent of the electrolyte is selected from fluoroethylene carbonate (FEC), ethyl methyl carbonate (EMC) and a mixture thereof.

8. The electrochemical cell according to claim 1, wherein the free-radical polymerization thermal initiator is azobisisobutyronitrile (AIBN).

9. The electrochemical cell according to claim 1, wherein the active material of the positive electrode comprises:
from 50 to 99% by mass of lithium manganese iron phosphate,
from 1 to 50% by mass of a lithiated oxide of nickel, manganese and cobalt (NMC) and/or a lithiated oxide of lithium, nickel, cobalt and aluminum (NCA) or a mixture thereof.

10. The electrochemical cell according to claim 1, wherein the lithium manganese iron phosphate has the formula:
LiₓMn_{1-y-z}Fe_{y}M_{z}PO₄ where 0.8≤x≤1.2; 0.5≤1-y-z<1; 0<y≤0.5; 0≤z≤0.2 and M is one or more chemical elements selected from the group consisting of B, Mg, Al, Si, Ca, Ti, V, Cr, Co, Ni, Cu, Zn, Y, Zr, Nb and Mo.

11. A method for in-situ thermal polymerization of a gelled polymer electrolyte in an electrochemical cell, said method comprising the steps of:
(a) providing an assembly comprising at least one positive electrode comprising an active material comprising a lithium manganese iron phosphate, at least one separator and at least one negative electrode comprising an active material,
b) inserting the assembly into a container,
c) preparing a liquid mixture comprising at least one solvent, a monomer comprising at least two acrylate groups, at least one lithium salt and a free-radical polymerization thermal initiator,
d) impregnating the assembly with the liquid mixture,
e) raising the temperature of the assembly to a temperature sufficient to cause crosslinking of the monomer comprising at least two acrylate groups for a period ranging from 2 to 24 hours.

12. The method according to claim 11, wherein step e) is carried out at a temperature ranging from 55 to 80° C.

13. The method according to claim 11, wherein in step c), a mass percentage of monomer in the liquid mixture represents from 1 to 20% by mass of the mass of the assembly formed by said at least one solvent, said at least one lithium salt and the free-radical polymerization thermal initiator.

14. The method according to claim 13, wherein in step c), the mass percentage of monomer in the liquid mixture represents from 2 to 7% by mass of the mass of the assembly formed by said at least one solvent, said at least one lithium salt and the free-radical polymerization thermal initiator.
